(19) United States
(12) Patent Application Publication
(10) Pub. No.: US 2014/0140656 A1
(43) Pub. Date: May 22, 2014

(54) Method to utilize string-strain-change induced by a transverse force and its application in fiber Bragg grating accelerometers

(71) Applicant: Kuo Li, Red Hill (AU)

(72) Inventor: Kuo Li, Red Hill (AU)

(21) Appl. No.: 13/971,849

(22) Filed: Aug. 21, 2013

(30) Foreign Application Priority Data
Aug. 24, 2012 (AU) 2012903661
Dec. 7, 2012 (AU) 2012101789

(51) Int. Cl. G01P 15/093

(52) U.S. Cl. CPC G01P 15/093
USPC 385/13

(57) ABSTRACT

When a transverse force is applied to a stretched string that is fixed by its two ends, the string bends and the strain of the string increases to balance the transverse force. As a result, the axial force along the string can increase much more than the transverse force applied.

By developing Fiber Bragg Grating (FBG) accelerometer based on transverse force rather than axial force, the force required for maintaining a high sensitivity is much smaller and thus the size of FBG accelerometers can be dramatically reduced. More importantly, FBG accelerometers based on transverse force have an inherent low cross-axial sensitivity.

Simultaneous measurement of acceleration, temperature and displacement is realized by using two under-tensioned FBG. Displacement change is calculated by using the differential of the two FBG results. Meanwhile temperature and acceleration is calculated by using the arithmetic mean of two FBG results, while temperature and acceleration are distinguished by applying low-frequency-pass and high-frequency-pass filter respectively to the arithmetic mean.

### TECHNICAL FIELD

This invention relates to the string-strain-change induced by forces and its application in Fiber Bragg Grating (FBG) accelerometers. For making the FBG accelerometer applicable to more application, simultaneously measuring temperature and displacement (can be converted to strain or force) is also included.

### BACKGROUND OF INVENTION

As the development of science and technology (i.e. the emerging of fiber Bragg grating), the change of the strain of a string can be easily measured. Based on the string-strain-change induced by a force, the force can be calculated.

String-strain-change induced by an axial force is proportional to the change of the axial force, which has been widely used at least in the field of fiber Bragg grating sensing field.

However, there has been no report on the relation between a transverse force and its induced string-strain-change yet. This invention presents the relation and applies it in fiber Bragg grating accelerometer.

### SUMMARY OF INVENTION

When a transverse force is applied to a stretched string that is fixed by its two ends, the string bends and the strain of the string increases to balance the transverse force. As a result, the axial force along the string can increase much more than the transverse force applied. The relations between the transverse force and its induced axial force are given in this application.

By developing Fiber Bragg Grating (FBG) accelerometer based on transverse force rather than axial force, the force required for maintaining a high sensitivity is much smaller and thus the size of FBG accelerometers can be dramatically reduced. More importantly, FBG accelerometers based on transverse force have an inherent low cross-axial sensitivity because it is more sensitive to transverse force than axial force.

For making the FBG accelerometer applicable to more application, simultaneously measuring temperature and displacement is realized by using two under-tensioned FBG. Displacement change is calculated by using the differential of the two FBG results. Meanwhile temperature and acceleration is calculated by using the arithmetic mean of two FBG results, while temperature and acceleration are distinguished by applying low-frequency-pass and high-frequency-pass filter respectively to the arithmetic mean.

Mainly, the following items have been proposed and claimed in this application.
1. A force amplifier, comprising:
   an object, responsive to an input, for providing a transverse force; and
   a scarcely stretched string fixed by its two ends, responsive to the transverse force applied at its middle, for providing a stronger axial force along itself.
2. A fiber Bragg grating accelerometer, comprising:
   an optical fiber having a Bragg grating thereon fixed on its measured object at two points of the fiber to include the Bragg grating between the two points, responsive to a transverse force, for reflecting a portion of an optical signal propagating in the fiber, the reflected portion having a wavelength that is modulated by the transverse force; and
   an inertial object connected to the middle of the fixed fiber, responsive to a transverse acceleration, for providing the transverse force.
3. A fiber Bragg gating accelerometer in claim 2, wherein the inertial object is confined by two transverse slots.
4. A fiber Bragg grating sensor, comprising:
   a rod, one of its two ends being connected to the measured object, responsive to the movement of the measured object, for providing a movement at its free end; and
   an optical fiber having a Bragg grating thereon, one point of the fiber being fixed to the measured object, another point of the fiber being connected to the free end of the rod, the Bragg grating being between the two points, responsive to the movements of both the free end of the rod and the measured object, for reflecting a portion of an optical signal propagating in the optical fiber, the reflected portion having a wavelength that is modulated by the movements.

### BRIEF DESCRIPTION OF THE DRAWINGS

In all the figures, 1 is a string; 2 is the place where a string or fiber is firmly fixed; 3a, 3b, 3c and 3d are objects that apply transverse forces; 3a is a rod that only moves vertically; 3b is a ball that is fixed on a string; 3c is a ball that is fixed on a fiber; 3d is a ring that encircles a fiber; 4 is a fiber; 5 is a Bragg grating; 6 is the shell of an accelerometer; 7 is a bolt; 8 is a spring that support the weight of an inertial object so that the string can be in shape of a straight line; 9 is a bar and four of them together confine the axial position of the ring 3d; 10a is a bar that connects with a string by ends; 10b is a lever; 11a is the place where the bar 10a is fixed and 11b is a rod that confines the lever 10b to rotate around; 12 is a connecting object having one end fixed between two Bragg gratings; 13 is a connecting object having two Bragg gratings fixed on it by their ends; 14 is a connecting object replacing 12 and 13.

FIG. 1 is a diagram of the transverse force from a vertical rod applying on a stretched string, where the string between its two fixed ends can move freely.

FIG. 2 is a diagram of the transverse force from a fixed ball applying on a stretched sting

The figures from FIG. 3 to FIG. 11 are all cross-section diagrams from one of axis of 3c or 3d.

FIG. 3 is the front view of an accelerometer.

FIG. 4 is the side view of a protection structure for the accelerometer shown in FIG. 3.

FIG. 5 is the front view of a protection structure for the accelerometer shown in FIG. 3.

FIG. 6 is the front view of a one-transverse-direction FBG accelerometer developed from the accelerometer shown in FIG. 3.

FIG. 7 is the side view of the one-transverse-direction FBG accelerometer shown in FIG. 6.

FIG. 8 is the side view of an accelerometer adapted from the accelerometer shown in FIG. 6 & FIG. 7.

FIG. 9 is the front view of a biaxial accelerometer.

FIG. 10 is the front view of a cross-axial-insensitive FBG accelerometer developed from the accelerometer shown in FIG. 6 & FIG. 7.

FIG. 11 is the side view of the cross-axial-insensitive FBG accelerometer shown in FIG. 10.

FIG. 12 is a diagram of a stretched string only subjecting to transverse force resulting from its own mass.

FIG. 13 is a diagram of a stretched string connected with a bar by ends.

FIG. 14 is an example of the bar shown in FIG. 13.

FIG. 15 is a diagram of a FBG sensor simultaneously measuring temperature, strain and acceleration.

FIG. 16 is a diagram of a derivative of the FBG sensor shown in FIG. 15.

FIG. 17 is an example of the connecting object 12 shown in FIG. 15.

FIG. 18 is an adaption from FIG. 16.

### DETAILED DESCRIPTION OF THE INVENTION

When a transverse force is applied to a stretched string that is fixed by its two ends, the string bends and the stain of the string increases. The axial force that is the force along the string increases as well.

Circumstance 1:

the string can move freely at the place where the transverse force applies.

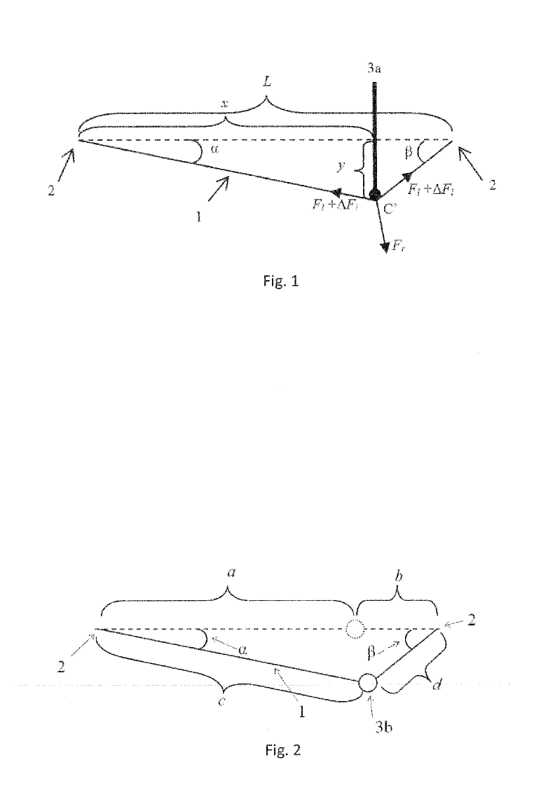

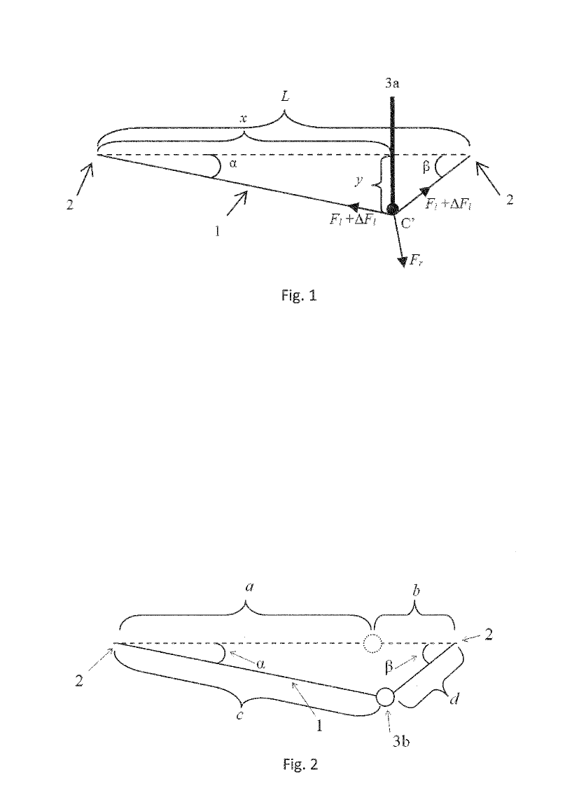

When the transverse force is applied by a vertically moving rod with a round, frictionless top, and the string is originally stretched horizontally as shown in FIG. 1, assuming the string can move freely at the place where the rod contacts, the strain of the string is uniform between its two fixed ends and the magnitude of axial force along the string is the same.

Assuming that the angles that the string is pushed away from its original place are α and β as shown in FIG. 1, it is obvious that in the vertical direction

$$\begin{matrix}{F}_{t} = ( {F}_{l} + Δ {F}_{l} ) ( sin α + sin β ) \\ = AE ( {ɛ}_{l} + Δ {ɛ}_{l} ) ( sin α + sin β )\end{matrix} \qquad ( 1 )$$

where Fₜ, Fₗ, ΔFₗ, ε, Δε, A and E are the vertical projection of Fᵣ (the force applied by the rod), original axial force, induced axial force by Fₜ, pre-strain, induced strain, cross-sectional area and Young's modulus of the string, respectively.

Assuming the string is pushed away y from its original place as shown in FIG. 1 and the length change of the string is ΔL, it is obvious that

$$sin α = \frac{y}{\sqrt{{x}^{2} + {y}^{2}}} \\ sin β = \frac{y}{\sqrt{{( L - x )}^{2} + {y}^{2}}} \\ Δ {ɛ}_{l} = \frac{Δ L}{L} = \frac{\sqrt{{x}^{2} + {y}^{2}} + \sqrt{{( L - x )}^{2} + {y}^{2}} - L}{L} \qquad ( 2 )$$

where x is the distance between the rod and one end of the string as shown in FIG. 1, L is the distance between the two fixed ends of the string.

Substitute the above equations into equation (1), it can be concluded that

$${F}_{t} = AE ( ɛ + \frac{\sqrt{{x}^{2} + {y}^{2}} + \sqrt{{( L - x )}^{2} + {y}^{2}} - L}{L} ) ( \frac{y}{\sqrt{{x}^{2} + {y}^{2}}} + \frac{y}{\sqrt{{( L - x )}^{2} + {y}^{2}}} ) . \qquad ( 3 )$$

Based on equation (2), y can be calculated from Δεₗ measured, and then based on equation (3), Fₜ can be calculated from y. So by measuring string-strain-change Δεₗ, the transverse force Fₜ can be calculated.

In its horizontal direction,

(Fₗ+ΔFₗ)cos α=(Fₗ+ΔFₗ)cos β+kFᵣ

where kFᵣ is the horizontal projection of Fᵣ. When α and β are small,

$$cos α \approx cos β {}^{( {F}_{l} + Δ {F}_{l} ) cos α \approx ( {F}_{l} + Δ F ) cos β} {kF}_{r} \approx 0$$

The closer to the middle the applied position, the smaller kFᵣ. For example, when x=0.65 L and 1% more strain change has been induced than that at its horizontal state, y=0.06769 L according to equation (2), cos α=0.65/\sqrt{0.65²+0.06769²}=0.995, cos β=0.982 and kFᵣ=0.013 (Fₗ+ΔFₗ). 64.7% (\sqrt{0.65²+0.06769²}=0.6535 L) of the string is at the left and 35.3% (0.3565 L) at the right. 0.3% (0.0030 L) has moved from the left to the right.

Circumstance 2:

a string cannot move freely at the place where transverse force applies.

When transverse force is applied by a ball that is fixed on the string as shown in FIG. 2, the strains of the string at two sides of the ball can be different, so the magnitudes of the axial forces at the two sides can be different. As shown in FIG. 2, a ball is fixed at a position that is originally at distances of a and b to each end. After the ball has been fixed on the string, the ball can apply a force on the string. When the ball applies a transverse force on the string, assume that the distances from the ball to each end become c and d respectively, as shown in FIG. 2.

Assuming that a) the angles that the string is pushed away from its original place are α and β as shown in FIG. 2, b) the increases of the axial forces are ΔFₐ and ΔF_{b} for the corresponding sides of the string, c) the strain changes of two sides of the string are Δεₐ and Δε_{b} respectively, it is obvious that

$$\begin{matrix}{F}_{t} = ( {F}_{l} + Δ {F}_{a} ) sin α + ( {F}_{l} + Δ {F}_{b} ) sin β \\ = AE ( {ɛ}_{l} + Δ {ɛ}_{a} ) sin α + AE ( {ɛ}_{l} + Δ {ɛ}_{b} ) sin β\end{matrix} \qquad ( 4 )$$

The net force on the ball in horizontal direction is zero, so

(Fₗ+ΔFₐ)cos α=(Fₗ+ΔF_{b})cos β

[symbol]

AE(εₗ+Δεₐ)cos α=+AE(εₗ+Δε_{b})cos β

[symbol]

(εₗ+Δεₐ)cos α=(εₗ+Δε_{b})cos β (5)

According to the law of cosines, it can be got that

$$cos α = \frac{{( a + b )}^{2} + {c}^{2} - {d}^{2}}{2 ( a + b ) c}$$

$$cos β = \frac{{( a + b )}^{2} + {d}^{2} - {c}^{2}}{2 ( a + b ) d}$$

$$\begin{matrix}sin α = \sqrt{1 - {cos}^{2} α} \\ = \sqrt{1 - {[ \frac{{( a + b )}^{2} + {c}^{2} - {d}^{2}}{2 ( a + b ) c} ]}^{2}}\end{matrix}$$

$$\begin{matrix}sin β = \sqrt{1 - {cos}^{2} β} \\ = \sqrt{1 - {[ \frac{{( a + b )}^{2} + {d}^{2} - {c}^{2}}{2 ( a + b ) d} ]}^{2}} .\end{matrix}$$

Also, it is obvious that

$$\begin{matrix}{Δɛ}_{a} = \frac{c - a}{a} & ( 6 ) \\ {Δɛ}_{b} = \frac{d - b}{b} & ( 7 )\end{matrix}$$

Substituting equations (6), (7) and those from law of cosine into equation (4) and equation (5), it can be got that

$$\begin{matrix}( {ɛ}_{l} + \frac{c - a}{a} ) \frac{{( a + b )}^{2} + {c}^{2} - {d}^{2}}{2 ( a + b ) c} = ( {ɛ}_{l} + \frac{d - b}{b} ) \frac{{( a + b )}^{2} + {d}^{2} - {c}^{2}}{2 ( a + b ) d} & ( 8 ) \\ {F}_{t} = AE ( {ɛ}_{l} + \frac{c - a}{a} ) \sqrt{1 - {[ \frac{{( a + b )}^{2} + {c}^{2} - {d}^{2}}{2 ( a + b ) c} ]}^{2}} + AE ( {ɛ}_{l} + \frac{d - b}{b} ) \sqrt{1 - {[ \frac{{( a + b )}^{2} + {d}^{2} - {c}^{2}}{2 ( a + b ) d} ]}^{2}} & ( 9 )\end{matrix}$$

Based on equations (6) to (9), F, can be calculated according to either Δεₐ or Δε_{b}. For example, when Δεₐ is measured, c can be calculated from equation (6), and then d can be calculated from equation (8), and lastly Fₜ can be calculated from equation (9).

Advantage of Inducing String-Strain-Change by a Transverse Force

To reveal the fact that a transverse applied on a string can induce a much larger axial force, it is alright to take the example that a ball is fixed in the middle of a string, so that this scenario covers both circumstances described before where the string can move freely and the string cannot move freely. Certainly, the string cannot move freely at the place where the transverse force applies because the ball that is fixed on the string divides the string into two parts. However, because the ball is in the middle, the two parts of the string always have the same strain and they would not move even if they could move.

It can be solved out from the equations in both circumstances that

$${F}_{t} = 2 AE ( {ɛ}_{l} + {Δɛ}_{l} ) \sqrt{1 - \frac{1}{{( {Δɛ}_{l} + 1 )}^{2}}} . \qquad ( 10 )$$

To get an insight of the physics meaning of equation (10), it is rearranged as

$$Δ {F}_{l} = \frac{1}{2 \sqrt{1 - \frac{1}{{( {Δɛ}_{l} + 1 )}^{2}}}} {F}_{t} - {F}_{l} . \qquad ( 11 )$$

Equation (11) shows clearly that a transverse force applied on a stretched string can induce a much larger axial force. The smaller Fₗ is, the more time Fₜ is amplified to ΔFₗ. The Fₗ can be very close to zero or even zero. Because Δεₗ is rising from zero along with Fₜ, Fₜ is amplified more times to ΔFₗ when Fₜ is small. In other words, to generate the same strain in a string, the transverse force required is much smaller than the axial force required. The smaller the required strain is, the more obvious this effect is.

For example, in FBG-sensor applications a FBG usually been stretched from 0.05-0.5%, which means that Fₜ will be amplified about from 15 to 5 times to ΔFₗ, when Fₗ is negligible. So FBG accelerometers based on transverse force inherently have a low cross-axial sensitivity.

To see its advantage from another perspective, for a random applied position in the circumstance 1, the amplification of the transverse force Fₜ is

ΔFₗ/Fₜ=Δε/[(ε+Δε)(y/\sqrt{x²+y²}+y/\sqrt{(L−x)²+y²})] (12).

When the transverse is applied at the middle (x=0.5 L),

Fₜ=2AE(ε+Δε)/\sqrt{2Δε+ΔεE²}/(Δε+1) (13),

ΔFₗ/Fₜ=Δε(Δε+1)/[2(ε+Δε)\sqrt{2Δε+ΔεE²}] (14),

When Δε≦1%, equations (13) and (14) can be approximately represented as below and the errors are less than 0.75%.

Fₜ≈2\sqrt{2}AE(ε+Δε)Δε^{1/2} (15),

ΔFₗ/Fₜ≈\sqrt{2}Δε^{1/2}/(4ε+4Δε) (16).

When ε>>Δε,

ΔFₗ/Fₜ≈\sqrt{2}Δε^{1/2}/(4ε)≈Fₜ/(8AEε²) (17).

When ε<<Δε,

ΔFₗ/Fₜ≈\sqrt{2}Δε^{1/2}/(4ε)≈(AE)^{1/3}/(2Fₜ^{1/3}) (18).

FBG's resonant wavelength shift induced by its strain change is

Δλ=λ(1−Pₑ)Δε=λ(1−Pₑ)ΔFₗ/(AE) (19),

where λ is the original resonant wavelength and Pₑ is the photo-elastic constant.

Theoretically, 0.1N transverse force applied at the middle of a scarcely stretched FBG will induce 1.03N axial force according to equation (18) and 1.47 nm resonant wavelength shift according to equation (19), taking typical values of FBG for AE 846.76N (3.1416*(0.125/2)²*6.9*10¹⁰), Pₑ 0.22 and λ 1550 nm. Because the resonant wavelength shift is 10.3 times larger than that 0.1N axial force induces, the FBG is 10.3 times more sensitive to 0.1N transverse force and the nonlinear sensitivity of such an FBG force sensor is improved as many times as the amplification of the transverse force.

The optimum for the largest amplification is that the pre-strain is negligible and the transverse force is the smallest as indicated by equation (18), and the applied position is at the middle because of the symmetry of this problem and comparisons between the theoretical amplifications of the same transverse force applied at different positions calculated based on equations (2), (3) and (12) by designating an increasing y. The comparisons show that the close to the middle, the larger the amplification. Theoretically, the amplification is infinite for an infinitesimal force at zero pre-strain when applied at the middle, shown by equation (18).

Its Application in Fiber Bragg Grating (FBG) Accelerometer

Various FBG accelerometers have been developed by applying axial force to FBG, such as those shown below.
1. Morikawa, S. R. K., et al. (2002). Triaxial Bragg grating accelerometer. 15th Optical Fiber Sensors Conference Technical Digest, page 95-98.
2. Sun, L, et al. (2009). A Novel FBG-based Accelerometer with High Sensitivity and temperature compensation. Sensors and Smart Structures Technologies for Civil, Mechanical, and Aerospace Systems 2009, Proc. of SPIE, Vol. 7292, 729214.
3. Antunes, P., et al. (2011). Uniaxial fiber Bragg grating accelerometer system with temperature and cross axis insensitivity. Measurement 44(1): 55-59.
4. Costa Antunes, P. F., et al. (2012). Biaxial Optical Accelerometer and High-Angle Inclinometer With Temperature and Cross-Axis Insensitivity. Ieee Sensors Journal 12(7): 2399-2406.
5. PCT/US2005/023948, Fiber optic accelerometer.
6. PCT/US99/01982, Accelerometer featuring fiber optic bragg grating sensor for providing multiplexed multi-axis acceleration sensing.

In reference 1, FBG-strain-change was induced by an inertial object that was only connected with the fibers and applied axial force on the fibers for sensing, while the authors ignored the transverse forces.

In references 2-6, FBG-strain-change was induced by an inertial object that was supported by others rather than the fiber and applied axial force on the fiber for sensing. In all these cases, the transverse forces were ignored as well.

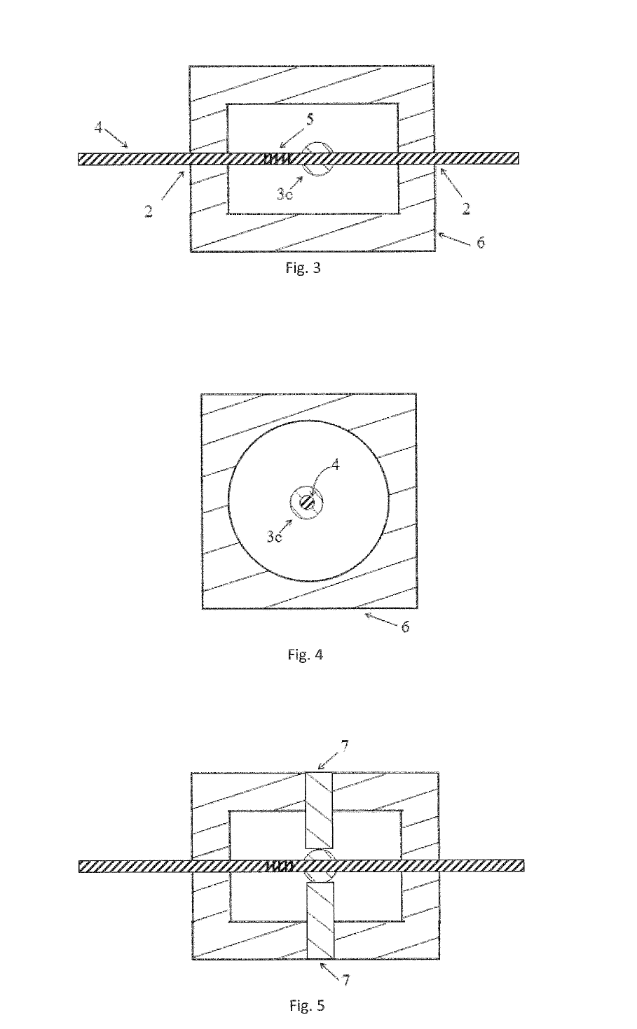

By applying transverse force instead of axial force, the size of an FBG accelerometer can be dramatically reduced while still maintaining a high sensitivity. The schematic setup of an FBG accelerometer in this application is shown in FIG. 3. It uses a stretched fiber to support an inertial object. Before an inertial object is fixed on the fiber, the fiber was pre-stretched a little and the original strain of the fiber can be calculated by the shift of resonance Bragg wavelength.

After the FBG has been pre-stretched and fixed well, an inertial object is fixed in the middle of the fiber between its two fixing ends, as shown in FIG. 3. The inertial object can be a ball which consists of two parts that can be glued together on the fiber. The transverse force induced on the fiber by the ball can be calculated by the shift in the resonance wavelength as

$${F}_{t} = 2 AE ( ɛ + \frac{{Δλ}_{B}}{{λ}_{B} ( 1 - {P}_{e} )} ) \sqrt{1 - \frac{1}{{( \frac{{Δλ}_{B}}{{λ}_{B} ( 1 - {P}_{e} )} + 1 )}^{2}}} \qquad ( 20 )$$

where Pₑ is the photo-elastic constant, λ_{B} is the resonance Bragg wavelength, and Δλ_{B} is the shift of the resonance Bragg wavelength from the condition FBG being pre-stretched.

The relation between the force from an inertial object and its acceleration are given by Newton's Second Law (F=ma). When the force from an inertial object is know, its acceleration is also clear. Therefore, the acceleration of the ball in FIG. 3 can be present as

$$a = \frac{2 AE}{M} ( ɛ + \frac{{Δλ}_{B}}{{λ}_{B} ( 1 - {P}_{e} )} ) \sqrt{1 - \frac{1}{{( \frac{{Δλ}_{B}}{{λ}_{B} ( 1 - {P}_{e} )} + 1 )}^{2}}} \qquad ( 21 )$$

where M is the mass of the ball.

To protect the sensor from being broken by a strong, out-range acceleration, the shell can be made with a round inner side, as shown in FIG. 4. Also, the distance between the ball and the shell can be limited as such that the fiber will not break when the ball touches the shell. Meanwhile, a force-absorbing layer can be placed on the round surface of the shell where the ball can reach, or the ball can be made of bouncing material. To further protect it in transportation, the ball can be fixed by two screws as shown in FIG. 5. The tip of the screw where it contacts with the ball can be covered with a force-absorbing layer.

To increase the tunability of the accelerometer, the place where the fiber is fixed on the shell can be tuned by using structures such as those Yoffe used (Yoffe G. W., et al. (1995) Passive temperature-compensating package for optical fiber gratings, Appl. Opt. 34:6859-6861).

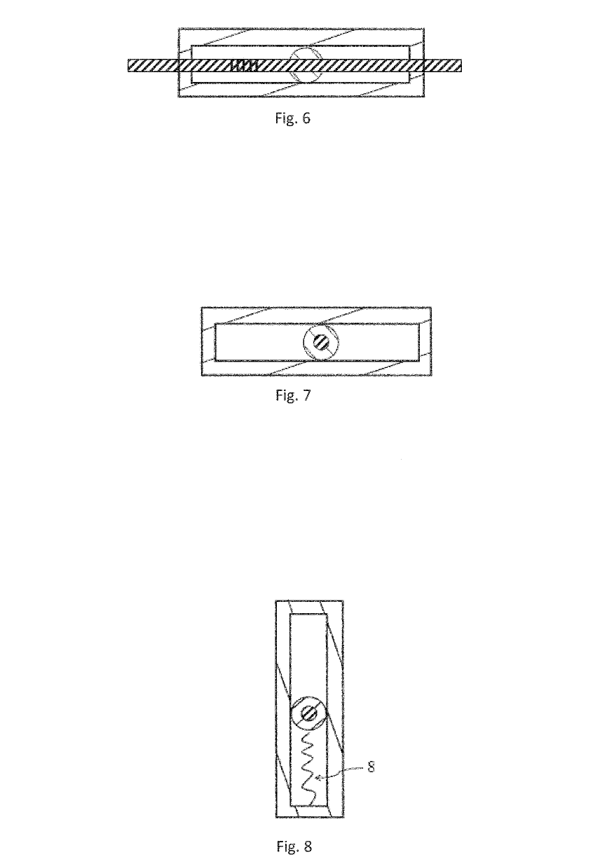

The accelerometer shown in FIG. 3 responds to transverse forces from any direction. To confine the accelerometer to work in one transverse direction, the shell is made with rectangular inner sides as shown in FIG. 6 and FIG. 7. Two sides of the shell can be narrowed to the dimension of the ball so that it cannot move in that direction and is confined to move in only one transverse direction. For reducing the fraction between the inertial object and the shell while confining the movement of the inertial object, the wall of the shell can be lubricated. To reduce temperature influence, the materials of the inertial object and the shell can be made from the same low thermal-expansion-coefficient material.

When measuring acceleration along gravitation direction, a spring 8 can be introduced to balance gravity as shown in FIG. 8. The spring does not have to be fixed on the inertial object. The place where spring is fixed on the shell can be tuned, so that the mass of the inertial object can be balanced to the maximum and the accelerometer can be very sensitive to any change of acceleration. At the place where the spring contacts with the inertial object, a bar can be fix on the spring and the the inertial object can have a rectangular shape. Instead of using a string, other bouncing material also can be used to support the inertial object, which can result in more compact structure. Furthermore, this spring structure can be used at two sides of the inertial object as damping structure to reduce the influnce of natural frequence of the string, with a tradeoff in decreasing the sensitivity.

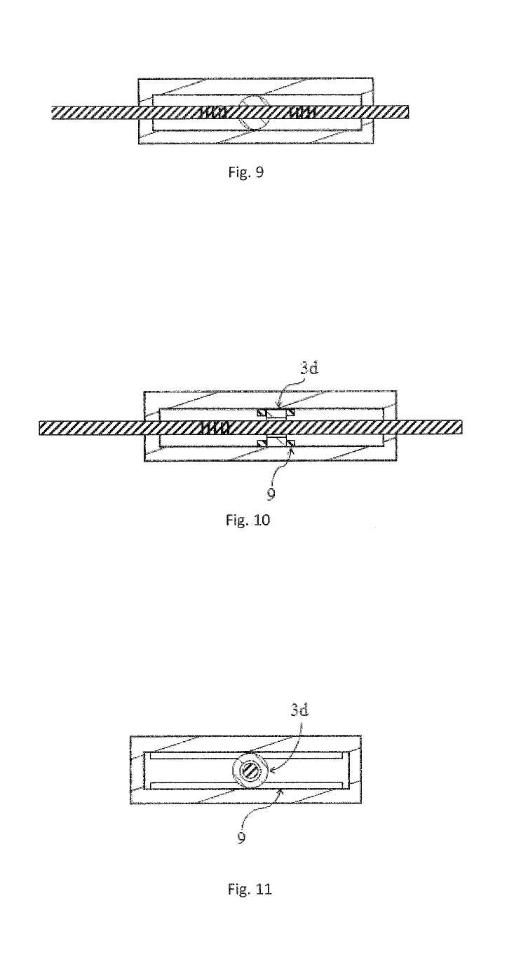

The accelerometers shown in FIG. 3, FIG. 6 & FIG. 7 in this application cannot distinguish between transverse acceleration and axial acceleration. The accelerometer can be adapted to do so by using two FBGs as shown in FIG. 9. For the transverse acceleration, both FBGs change in the same direction, either increasing together or decreasing together; for the axial acceleration, the two FBGs change conversely. Therefore, the transverse acceleration can be calculated by using the change of the arithmetic mean of the resonance wavelengths of the two FBGs, while the axial acceleration can be calculated by using the change of the differential of the wavelengths of the two FBGs. It should be noted that using the change of the differential increase the axial sensitivity by a factor of 2, as explained in reference 3.

To reduce the axial response of the accelerometer shown in FIG. 6 & FIG. 7, the inertial object 3d can be in shape of a ring encircling the fiber but not fixing on it, as shown in FIG. 10 and FIG. 11. The four bars 8 confines the axial position of the ring 3d. Obviously, axial forces from the ring will be balanced by the four bars, while transverse forces from the ring works according to equations (2) and (3). For reducing the friction between the inertial object 3d and the bars, the inertial object 3d can be made in shape of an oval or cut ball to reduce the contacting area.

The influence of temperature fluctuation has to be taken into account because FBG is inherently sensitive to temperature. For an accelerometer, temperature influence can be eliminated by applying high-pass filtering to its data because temperature fluctuation has a very low frequency.

Moreover, the natural resonance frequency of the accelerometers in this application can be controlled by changing either the pre-strain of the FBG, the length between its fixed ends or the mass of the inertial object. Assume that the transverse force is applied at the middle, the axial force at the equilibrium position is Fₗₑ, the displacement of the inertial object from the equilibrium position is u, and the gravitational direction is the positive oscillation direction, so for small degree approximation

$$∵ M \frac{{d}^{2} u}{d {t}^{2}} = - 2 {F}_{le} \frac{u + y}{L / 2} + Mg \\ 2 {F}_{le} \frac{y}{L / 2} = Mg \\ ∴ M \frac{{d}^{2} u}{d {t}^{2}} = - 2 {F}_{le} \frac{u}{L / 2} \\ ⇒ \frac{{d}^{2} u}{d {t}^{2}} + \frac{4 {F}_{le}}{ML} u = 0 \\ ⇒ u = cos \sqrt{\frac{4 {F}_{le}}{ML}} t \qquad ( 22 )$$

where y is the displacement of the equilibrium position from the original position. Its resonant frequency is \sqrt{Fₗₑ/ML}/π. In cases where there is a horizontal plane supporting the weight of the inertial object and it only oscillates horizontally as shown in FIG. 6 and FIG. 7, Fₗₑ equals Fₗ and the resonant frequency is still \sqrt{Fₗₑ/ML}/π.

The parts of fiber which contact with others can be protected by either putting some glue on them or curving the contacting surface.

Furthermore, the sensitivities of these accelerometers in this application can be easily controlled by changing the inertial object. According to Newton's Second Law, for the same acceleration, the heavier the inertial object is, the stronger the force is and thus the more sensitive the accelerometer is.

Because the strain that a fiber can stand is limited, measurement ranges of these accelerometers decrease when their sensitivities increase. The mass of the fiber with a diameter about 125 micrometers has been neglected because the force resulting from it is usually much smaller than that from an inertial object. However, for getting a very high measurement range of acceleration, the inertial object could be eliminated and the mass of the fiber could be utilized.

When a stretched string only subjects to the transverse force resulting from its mass as shown in FIG. 11, the strain distribution along the string is not uniform. For a random point P on the string, the transverse force it subjects is

$$\begin{matrix}{F}_{t} = ( {F}_{l} + Δ {F}_{l} ) sin γ \\ = AE ( {ɛ}_{l} + {Δɛ}_{p} ) sin γ\end{matrix} \qquad ( 23 )$$

where γ is the angle between the first derivative of the curve at point P and the horizontal line as shown in FIG. 11.

This circumstance can be view as a standing transverse wave, where all the points on the string just move vertically like a boat moves up and down in a water wave. So the strain change at point P is

$$\begin{matrix}{Δɛ}_{p} = \frac{Δ d l}{d l} \\ = \frac{\frac{dl}{cos γ} - dl}{dl} \\ = \frac{1}{cos γ} - 1\end{matrix} \qquad ( 24 )$$

where dl is assumed as a very small length of the string around point P when the string is in shape of a straight line rather than a curve, and Δdl is assumed as the change of dl.

From equations (23) and (24), it can be got that

$${F}_{t} = AE ( {ɛ}_{l} + {Δɛ}_{p} ) \sqrt{1 - \frac{1}{{( {Δɛ}_{p} + 1 )}^{2}}} . \qquad ( 25 )$$

It is alright to assume the linear density (μ) and shape of the string is the uniform when it is relaxed. Because of the symmetric shape of the string within its fixed ends, the transverse force at point P is

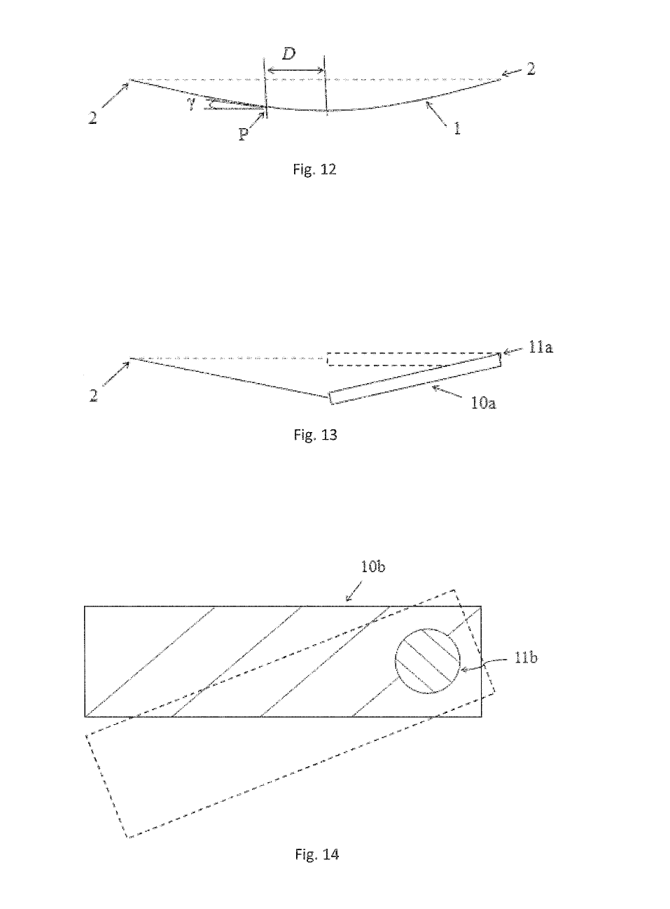

Fₜ=ma=μDa (26)

where D is the distance between point P and the middle of the string as shown in FIG. 12 and m is the mass of the part of the string within D.

From equations (25) and (26), it can be got that

$$a = \frac{AE}{μ D} ( {ɛ}_{l} + {Δɛ}_{p} ) \sqrt{1 - \frac{1}{{( {Δɛ}_{p} + 1 )}^{2}}} . \qquad ( 27 )$$

If there is a Bragg grating around point P and the length of Bragg grating is much shorter than the length of the string, the strain change of the Bragg grating can be treated as uniformly and the acceleration at point P can be presented as

$$a = \frac{AE}{μ D} ( {ɛ}_{l} + \frac{{Δλ}_{B}}{{λ}_{B} ( 1 - {P}_{e} )} ) \sqrt{1 - \frac{1}{{( \frac{{Δλ}_{B}}{{λ}_{B} ( 1 - {P}_{e} )} + 1 )}^{2}}} . \qquad ( 28 )$$

Above discussion has not included the shape of string is not uniform or consisted by two uniform parts. A uniform string can connect with a bar as shown in FIG. 13, using the mass of the bar as the inertial mass. The string and the bar are connected by ends, while their other ends are fixed at 2 and 11 as shown in FIG. 13. When being fixed, the string is stretched a little and the string and the bar are in a straight line. When there is a transverse acceleration, the bar will change in position and thus apply a transverse force on the string.

Apart from measuring acceleration, it can also simultaneously measure length-change (displacement) between the two fixed points 2 and 11 as shown in FIG. 13, which will transfer to the string following the strength and length ratio between the bar 10a and the string. Usually, in FBG application, a connecting bar is much stronger and harder to pull, so all the displacement will be transfer to the string (FBG) and the strain and resonance wavelength of FBG will change accordingly. Whether a shift in the resonance wavelength is induced by the displacement or a transverse acceleration can be distinguished by judging whether the frequency of the shift agrees with expected the transverse acceleration or the displacement.

The displacement can be used to reflect temperature and strain, as Jung did (Jung J., et al. (1999) Fiber Bragg grating temperature sensor with controllable sensitivity, Appl. Opt. 38, 2752) and Li did (Li K., et al. (2009) A high sensitive fiber Bragg grating strain sensor with automatic temperature compensation, Chinese Optics Letters, 7(3):191-3).

The bar's movement can be confined by fixing its end differently such as one shown in FIG. 14, where the lever 10b is confined to move only in one transverse direction by a rod 11b and the relation between the transverse force from the bar and force from the string follows Lever Principle.

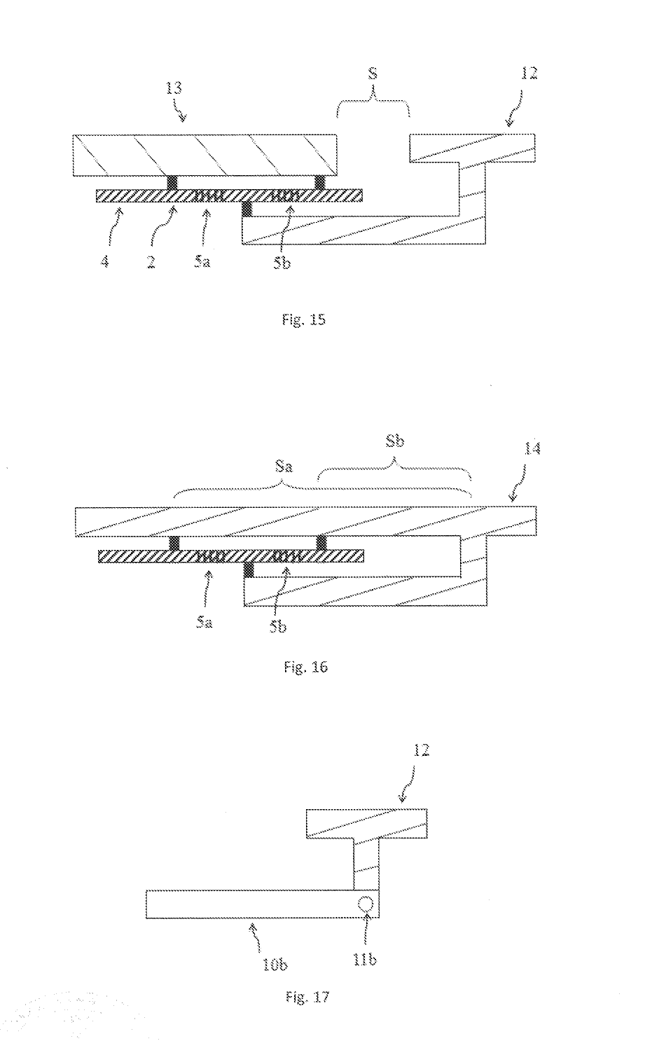

For a better distinguishing whether a shift in the resonance wavelength is induced by the displacement or a transverse acceleration and measuring temperature at the same time, two FBG are used as shown in FIG. 15. The displacement of S can be calculated by using the differential of the two FBG results. Meanwhile temperature and acceleration can be calculated by using the arithmetic mean of two FBG results, while temperature and acceleration are distinguished by applying low-frequency-pass and high-frequency-pass filter respectively to the arithmetic mean. For reducing the temperature influence on the length of the connecting objects 12 and 13, they can be made of low coefficient of thermal expansion material such as invar.

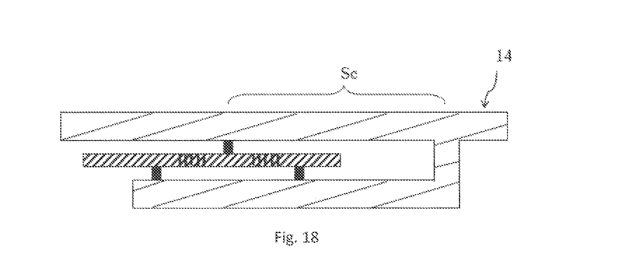

The displacement can also be used to reflect force by replacing 12 and 13 by the connecting object 14 as shown in FIG. 16. When a axial force applies on the two long ends of the connecting object 14, the Bragg grating 5a measures the change of Sa and the Bragg grating 5b measures the change of Sb. FIG. 18 shows a structure to make the Bragg gratings 5a and 5b measures the same length change Sc, which facilitates the measurement of the strain change between the long ends of the object 14.

Alternatively, the displacement can also be used to reflect force by putting a spring between the connecting object 12 and 13 and then confine them only move axially by connecting another object with 12 and 13.

This amplification may have possible surface applications where the displacement of the surface is small and every point of the surface approximately only moves perpendicularly to the original flat surface. The main difference between a surface and a string here is the cross-sectional area. In cases where a transverse force is applied to the center of a round, flat surface, for example surface-tension-based floating, assume that the angle formed is δ, so the transverse force to a ring r away from the center is

$${F}_{t} \approx 2 π rHE ( ɛ + Δɛ ) sin δ \approx 2 π rHE ( ɛ + Δɛ ) \sqrt{2 Δɛ + {Δɛ}^{2}} / ( Δɛ + 1 ) \approx 2 \sqrt{2} π rHE ( ɛ + Δɛ ) {Δɛ}^{1 / 2} , \qquad ( 29 )$$

where H is the thickness of the stretched surface, and for simplicity reason, the definitions for the string are still used here as if the stretched surface were a special string. Equation (29) agrees with the common sense that a sharp point can pierce a surface easily. For floating on a surface, Δε should not exceed the value that the surface can stand.

In round-surface pressure-driven cases, for example an eardrum, assume that the pressure on the surface is P, so the transverse force to a ring, r away from the center and with a angle θ formed by its tangent and the original flat surface, is

$$\begin{matrix}{F}_{t } = π {r}^{2} P \approx 2 π rHE ( ɛ + Δɛ ) sin θ \approx 2 \sqrt{2} π rHE ( ɛ + Δɛ ) {Δɛ}^{1 / 2} . & ( 30 ) \\ ∴ P \approx 2 \sqrt{2} HE ( ɛ + Δɛ ) {Δɛ}^{1 / 2} / r , & ( 31 ) \\ Δɛ / P \approx \sqrt{2} r {Δɛ}^{1 / 2} / ( 4 HE ɛ + 4 HE Δɛ ) . & ( 32 ) \\ When ɛ ≫ Δɛ , \\ Δɛ / P \approx \sqrt{2} r {Δɛ}^{1 / 2} / ( 4 HE ɛ ) \approx {r}^{2} P / ( 8 {H}^{2} {E}^{2} {ɛ}^{2} ) . \\ When ɛ ≪ Δɛ , & ( 33 ) \\ Δɛ / P \approx \sqrt{2} r {Δɛ}^{1 / 2} / ( 4 HE Δɛ ) \approx {{r}^{2 / 3} ( HE )}^{- 2 / 3} {P}^{- 1 / 3} / 2. & ( 34 )\end{matrix}$$

Equations (32)-(34) show the strategy to achieve a larger Δε or displacement of the surface at the same P and the large pre-strain of an eardrum could result in a severe hearing loss.

1. A force amplifier, comprising:
an object, responsive to an input, for providing a transverse force; and
a scarcely stretched string fixed by its two ends, responsive to the transverse force applied at its middle, for providing a stronger axial force along itself.

2. A fiber Bragg grating accelerometer, comprising:
an optical fiber having a Bragg grating thereon fixed on its measured object at two points of the fiber to include the Bragg grating between the two points, responsive to a transverse force, for reflecting a portion of an optical signal propagating in the fiber, the reflected portion having a wavelength that is modulated by the transverse force; and
an inertial object connected to the middle of the fixed fiber, responsive to a transverse acceleration, for providing the transverse force.

3. A fiber Bragg gating accelerometer in claim 2, wherein the inertial object is confined by two transverse slots.

4. A fiber Bragg grating sensor, comprising:
a rod, one of its two ends being connected to the measured object, responsive to the movement of the measured object, for providing a movement at its free end; and
an optical fiber having a Bragg grating thereon, one point of the fiber being fixed to the measured object, another point of the fiber being connected to the free end of the rod, the Bragg grating being between the two points, responsive to the movements of both the free end of the rod and the measured object, for reflecting a portion of an optical signal propagating in the optical fiber, the reflected portion having a wavelength that is modulated by the movements.
